(19) United States
(12) Patent Application Publication
(10) Pub. No.: US 2003/0145737 A1
(43) Pub. Date: Aug. 7, 2003

(54) Bread making machine driven by alternating current motor with reduction gear unit

(76) Inventor: Donglei Wang, Zhuhai (CN)

Correspondence Address: GREENBERG TRAURIG LLP, 2450 COLORADO AVENUE, SUITE 400E, SANTA MONICA, CA, 90404, US

(21) Appl. No.: 10/318,255

(22) Filed: Dec. 10, 2002

(30) Foreign Application Priority Data
Feb. 5, 2002 (CN) 02225753.5

(51) Int. Cl. A23L 1/00

(52) U.S. Cl. 99/348; 99/327

(57) ABSTRACT

The present invention includes a casing, a baking oven, a bread making chamber unit, an electrical heating tube, an alternating current motor unit with a reduction gear unit, a upper lid unit, a mixing rod and control unit. The alternating current motor unit is directly installed in the casing and the baking oven is disposed on the gear case of the alternating current motor unit. The bread making chamber unit is directly connected to the gear case and is disposed in the baking oven together with the electrical heating tube. The alternating current motor unit is constituted by an alternating current motor and the reduction gear unit which are connected by a shaft. A rotating fork connected to the reduction gear unit is connected to the mixing rod in the bread making chamber unit. According to the present invention, the security and reliability are improved, and the life of the components is increased, the configuration of the bread making machine is simplified and the cost of it is decreased.

### FIELD OF THE INVENTION

The present invention relates to a bread making machine, and more particularly to a bread making machine driven by an alternating current motor with a reduction gear unit.

### DESCRIPTION OF THE PRIOR ART

Recently, in the conventional bread making machines, single-phase alternating current motors or permanent-magnet direct current motors are generally used as the driving source, and they drive the other moving parts after reducing by reduction mechanism. Since the power supply and reduction mechanism for this kind of bread making machine are two separate parts, the transmission parts is increased and therefore the configuration and the assembling process are complicated and which also leads to the higher cost. In addition, since the motor is generally disposed outside a baking oven, it is considerably affected by heat from the baking oven. Thus, the performance of the motor is adversely affected.

### SUMMARY OF THE INVENTION

An object of the present invention is to provide a bread making machine driven by an alternating current motor with a reduction gear unit so as to simplify the configuration of the bread making machine and to decrease its manufacturing cost. The operating performance of the bread making machine is improved by placing the motor in the lower portion of the bread making machine.

In order to accomplish the above object, the present invention provide a bread making machine driven by an alternating current motor with a reduction gear unit, wherein the shaft of the motor is engaged with the reduction gear unit directly, and the reduction gear unit is connected to a bread making chamber.

The motor and the reduction gear unit are integrated together and disposed below a baking oven in a casing.

The reduction gear unit comprises a transmission gear, the transmission gear is engaged with the shaft of the motor, the shaft of the transmission gear is connected to a rotating fork shaft in a bread making chamber.

The present invention is different from the conventional bread making machine in that:

1. The power supply of the present invention is the alternating current motor unit 5 formed by integrating the reduction gear unit 12 and the alternating current motor 13 together, the rotation speed of the output shaft of the alternating current motor unit 5 is equal to that of the operating rotation speed of the bread making machine. The rotation of the mixing rod 2 of the bread making chamber 8 is directly driven by the rotating fork 9 provided on the output shaft. It is not necessary to provide additional reducing mechanism for the bread making machine, so the number of transmission parts is reduced and its configuration is also simplified. Thus, the cost of the bread making machine is inexpensive.

2. The alternating current motor unit 5 is disposed below the bottom of the baking oven 7, and the baking oven 7 is abutted on the gear case 10 of the alternating current motor unit 5. The mixing rod 2 in the bread making chamber 8 is connected directly to the gear case 10.

Accordingly, the present invention further has the following advantages:

(1) The security and reliability are improved, and the life of the components is increased.

Since the alternating current motor unit 5 is disposed below the baking oven 7, and the control circuit may be provided below the baking oven 7 due to the large space below the baking oven, the alternating current motor unit 5 and the control panel unit 3 are less affected by the temperature of the baking oven. Therefore, the temperature of the surroundings in which the units are used is reduced, so the operating reliability of the units is improved and the life thereof is correspondingly increased.

(2) The configuration of the bread making machine is simplified and the cost of it is decreased.

### BRIEF DESCRIPTION OF THE DRAWINGS

FIG. 1 is a structural schematic view of the present invention;

FIG. 2 is a schematic view showing the configuration of the alternating current motor unit according to the present invention.

### DESCRIPTION OF THE PREFERRED EMBODIMENTS

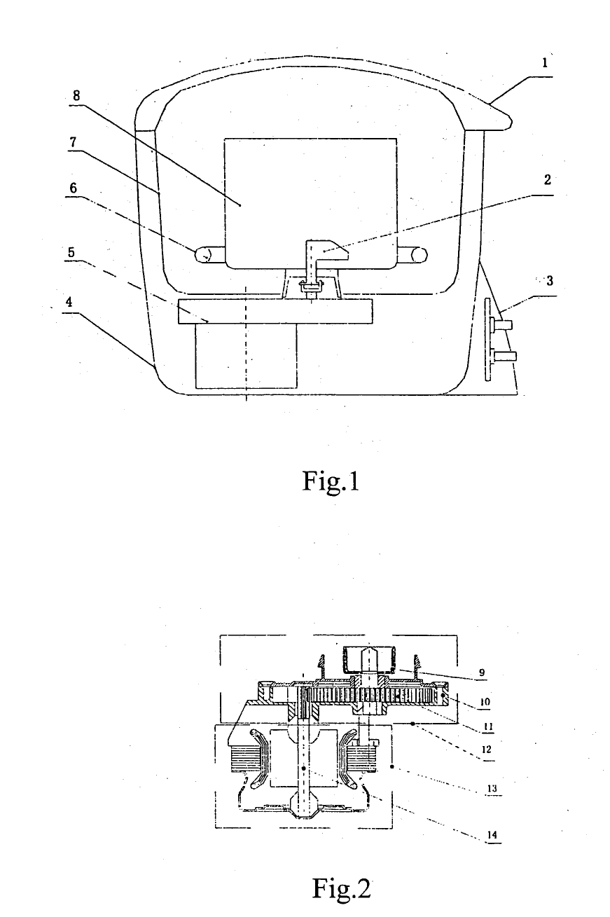

As shown in FIG. 1, the present invention includes a casing 4, an upper lid unit 1, a control panel unit 3, a mixing rod 2, a baking oven 7, a bread making chamber unit 8, and an electrical heating tube 6, an alternating current motor unit 5 disposed directly below the baking oven 7 in the casing 4. The bread making chamber 8 and the electrical heating tube 6 are disposed inside the baking oven 7. The mixing rod 2 in the bread making chamber 8 is provided at the bottom of the bread making chamber 8 and connected to the alternating current motor unit 5.

As shown in the FIG. 2, the alternating current motor unit 5 is constituted by the alternating current motor 13 and the reduction gear unit 12. The reduction gear unit 12 comprises the transmission gear 11 and the gear case 10. The gear shaft 14 of the motor 13 is engaged with the transmission gear 11. The shaft of the transmission gear 11 is connected to the mixing rod 2 by the rotating fork 9. The speed of the gear shaft 14 of the motor 13 is reduced by the transmission gear 11 and the power of the motor 13 is transmitted to the rotating fork 9 which in turn rotate the mixing rod 2 in the bread making chamber 8. The transmission gear 11 is protected by providing the gear case outside it. The motor 13 and the reduction gear unit 12, which are integrated together, are secured in the casing 4 and below the baking oven 7.

Specific Embodiments:

The casing 4 is the main body of the bread making machine and is generally made of plastic or metal. The other parts are installed on or connected to the casing 4 having sufficient strength and rigidity.

The electrical heating tube 6 is fixed to the baking oven 7, which generates heat and radiates it inside the bread making chamber 8 through the baking oven 7 for baking bread.

The upper lid unit 1 is mainly composed of an upper lid plate, an upper lid liner, a view glass, and a ventilation window. The upper lid unit 1 functions as that in the following:

a. The heated fume flows to the outside in the manner of convection.

b. The state of the bread being baked can be observed through the viewing glass.

The bread making chamber unit 8 is mainly composed of the bread making chamber 8, the chamber seat, the rotating fork 9, the mixing rod 2 and the like. The bread making chamber unit 8 serves to mix the flour and provides a container for bread baking.

The control panel unit 3 is mainly composed of control components and circuit boards. The function of the control panel unit 3 is to control the bread making procedure by inputting various programs through press key according to recipe and to bake bread with various tastes.

What is claimed is:

1. A bread making machine driven by an alternating current motor with a reduction gear unit, which is characterized in that the shaft of the motor is engaged with the reduction gear unit directly, and the reduction gear unit is connected to a bread making chamber.

2. The bread making machine driven by an alternating current motor with a reduction gear unit as set forth in claim 1, wherein the motor and the reduction gear unit are integrated together and are disposed below a baking oven in a casing.

3. The bread making machine driven by an alternating current motor with a reduction gear unit as set forth in claim 1, wherein the reduction gear unit comprises a transmission gear, the transmission gear is engaged with the shaft of the motor, the shaft of the transmission gear is connected to a rotating fork shaft in a bread making chamber.
